(19) United States
(12) Patent Application Publication
(10) Pub. No.: US 2007/0116239 A1
(43) Pub. Date: May 24, 2007

(54) Method and system for providing telephone communications between a website visitor and a live agent

(76) Inventors: Yaniv Jacobi, Kiryat Ono (IL); Phillipe Lang, White Plains, NY (US); Gabriella Berger, Ramat Gan (IL)

Correspondence Address: GOTTLIEB RACKMAN & REISMAN PC, 270 MADISON AVENUE, 8TH FLOOR, NEW YORK, NY, 100160601, US

(21) Appl. No.: 11/248,379

(22) Filed: Oct. 11, 2005

(51) Int. Cl. H04M 3/00; H04M 5/00

(52) U.S. Cl. 379/265.02

(57) ABSTRACT

A website run by a server can be accessed by many visitors. Services and support for the website are provided by a live agent that can engage the visitors in verbal conversations. A conversation is initiated when a visitor requests telephone assistance on the website. Information about the visitor, including pages he has visited in a current or previous visit is placed in a data file or record. In response to the request, the live agent obtains the record corresponding to the visitor and makes a telephone call (preferably using a VOIP telephone) to the visitor to provide the information requested.

### RELATED APPLICATIONS

None.

### BACKGROUND OF THE INVENTION

1. Field Of Invention

This invention pertains to a method and system for providing automated telephone communications between a website visitor and a live agent. The invention is particularly useful for websites used for e-commerce.

2. Description of the Prior Art

Originally, the Internet was used by many people as a source of free information or as a source of entertainment. However, various advances in the field led to the establishments of virtual stores run by e-commerce merchants for selling various goods and services. These virtual or ‘on line’ stores are used by potential customers in the same way as in the ‘real’ or so-called ‘brick-and-mortar’ stores. That is, people often visit and browse through both types of stores to see what is available, and shop around for prices.

In both kinds of stores, human interaction becomes crucial to convince a visitor who is “just browsing” to become a customer. In the real store, this task is performed by a skilled salesman. In ‘virtual’ stores, a similar function is available as well, usually in the form of a live chat during which the visitor and the agent exchange text messages. During these chats the visitor receives information and answers to questions related to the products and services being offered. While a chat is going on the agent may have access to various information about the visitor, including the pages on the site that the visitor has seen, the contents of his shopping cart, if any, and in some instances, even details of previous visits to the website. As a result, the agent is much more versed in what the visitor's interests are even before engaging in the chat session. Thus, the exchange between the visitor and the agent is much more effective and informative for both parties. A system that allows a visitor to see a web site and interface with an agent in this manner is available from LivePerson, Inc., New York, N.Y.

In some instances, visitors prefer to talk to an agent rather then communicating via a chat session. However, if the visitor calls up an agent, the agent does not have the same information about the visitor as during a chat session, and, accordingly, servicing a visitor through a telephone call is much less informative and satisfactory for both parties.

### SUMMARY OF THE INVENTION

A system is presented that may be used to implement e-commerce or provide other information and services to various visitors. The system includes a server connected to the Internet and providing access to a website associated with the server. The website is reviewed by many visitors, the activities of the visitors are monitored and a record is stored so that it becomes available each time a visitor returns to the website.

The system includes a workstation that allows access to the system by a live agent for the purpose of assisting visitors. Visitors can communicate with the live agent either by an (optional) on-line chatting feature provided by the server or by establishing a telephone communication channel. For establishing a telephone call, a visitor is presented with a link (embedded in image or text) on one or more pages of the website. A visitor can then request a telephone call by activating the link. After providing his telephone number, the visitor is placed in a queue for the live agents. The information for each visitor in the queue is presented to a live agent, while the visitor is notified on his current status, which includes (but not limited to) his place in the queue and the expected waiting time. Optionally, current waiting times for accessing live agents may be displayed on the website so that they can be seen even by visitors who have not yet requested a call or who have no interest in a live telephone call with and agent.

When he becomes available, an agent reviewed the queue (or queues if there are more than one), reviews the information presented to him by the system on the visitors, and then selects one of the visitors.

Preferably, once an agent selects a waiting visitor, the system dials the telephone number of the visitor, and the agent and the visitor can then engage in conversation preferably while viewing the same pages of the website. The agent can respond to verbal questions by the visitor, and can provide information by pushing webpages to the visitor and other similar means. The agent and the visitor can co-browse the website, co-navigate the website and can cooperate in filling out forms, such as an order form for a product or service.

After an encounter with a visitor is completed, the agent generates a record of the encounter including information about the visitor. The information is stored in a file kept for the visitor and/or used for marketing studies.

### BRIEF DESCRIPTION OF THE DRAWINGS

FIG. 1 shows a block diagram of a system constructed in accordance with this invention;

FIG. 2 shows a flow chart for the system describing the initial processing of a visitor to a subject website;

FIG. 3 shows a flow chart for the system indicating how the actions of the visitor are monitored by the system and how the system handles requests for telephone assistance;

FIG. 4 shows a flow chart for the queuing telephone assistance requests; and

FIG. 5 shows a flow chart for the system indicating the interaction between the agent and the visitor during a telephone conversation.

### DETAILED DESCRIPTION OF THE INVENTION

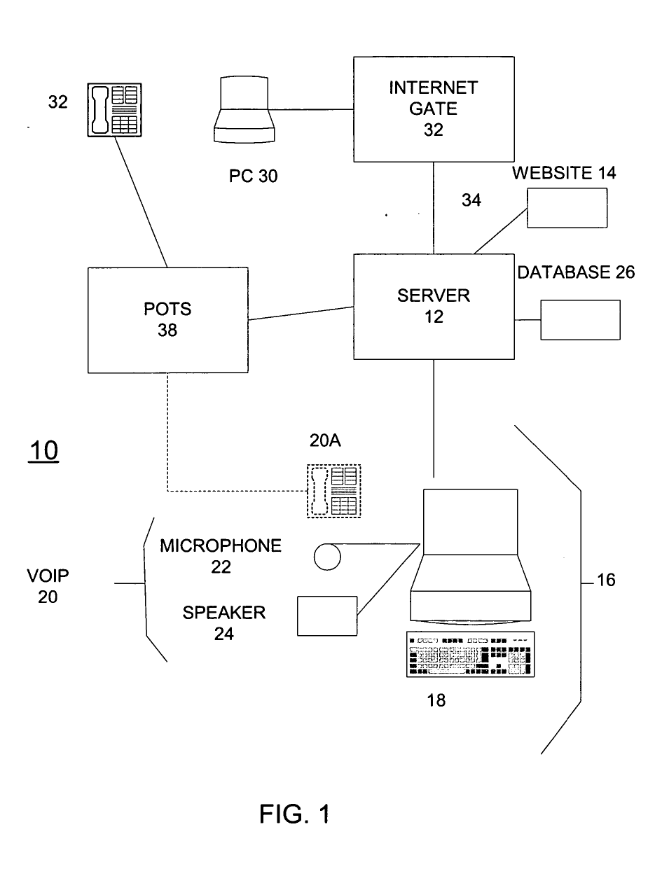

Referring now to FIG. 1, a system 10 is illustrated that includes a group of servers 12 hosting a website 14 and running various backend applications. The website 14 may be run, for example, by an e-commerce merchant selling goods or services. While many of the operations of the website are automated, some personalized service is provided by a live agent from a workstation 16. The workstation 16 includes a PC or other similar equipment that allows the live agent to monitor what is happening on the website 14, and to interact with visitors as described in more detail below. Preferably, the agent can talk with website visitors through an Internet telephone 20 using VOIP. The telephone 20 includes a microphone 22 and a speaker 24, both coupled to the workstation 16.

A visitor having an Internet access device 30 such as a PC, or other similar means, can access the website 14 by establishing a connection to his Internet gate 32, which then couples the visitor to server 12 via the Internet 34 in the normal manner. Of course, it should be understood that a large number of visitors can access the website 14 through appropriate Internet connections, and that a single visitor is shown herein for the sake of simplicity.

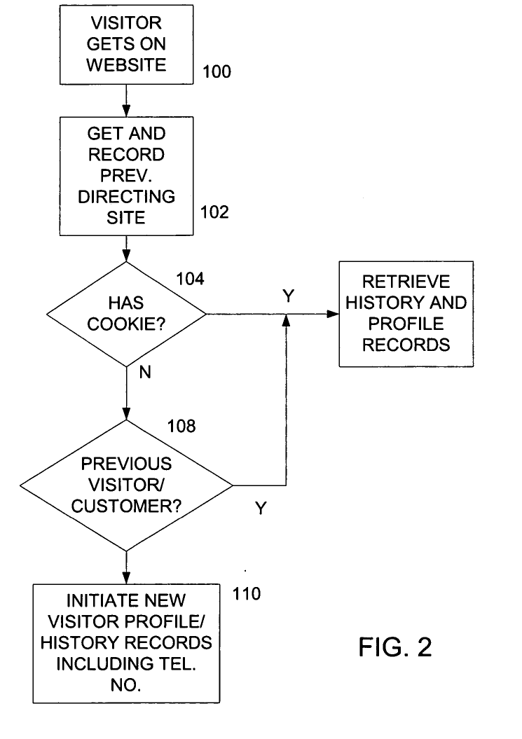

FIG. 2 shows how the server 12 handles each visitor. In step 100 a visitor gets on the website 14, either directly, e.g., by using the URL number of the website 14 or by being directed to it from another site, such as a search engine, a website that includes e-commerce merchant listings, etc. In step 102 the tracks of the visitor are reviewed to identify and record the referring site (if any). This information is used for many purposes, including statistical studies to determine how visitors find the website 14. Moreover, the respective e-commerce merchant may have agreements with third parties which require the merchant to pay them for any referred visitors.

Next, the identity of the visitor is established. This can be accomplished in a number of different ways. For example, in step 104 the server 12 may determine if the visitor's PC 30 has any cookies indicating a prior visit. If a cookie is found, then it is retrieved and used in step 106, to retrieve the visitor's record. This record can consist of various information, including name, e-mail address, physical address, telephone number, credit card used, list of pages viewed in previous visits, list of goods and services bought, goods and services on his wish list, etc. If no cookie is found in step 106, then in step 108 the visitor is given the opportunity to identify himself as either a previously registered visitor or customer by entering his name and password. These items are then used in step 106 to retrieve the appropriate record for the visitor. If this is a first visit, then in step 110 the visitor is given the opportunity to become a registered visitor and provide the information required to generate a record. Of course, the visitor may decide not to be registered, in which case a record may be started and used at least for this visit. When the visitor signs off and/or leaves the site 14, his record may still be stored and kept until his next visit. The records of visitors are stored in databases in memory 26. The information from step 102 regarding the referring site that directed the visitor to the present site 14 is made a part of the record for the visitor and/or added to other data bases. Information, such as what search words were used on another search engine to arrive at the present site may also be stored.

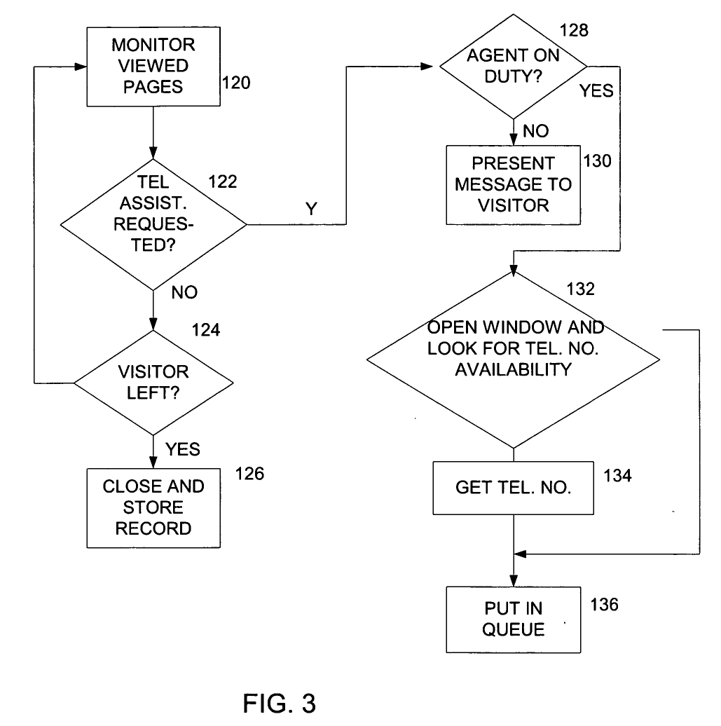

Once the visitor is on the website (and hopefully, but not necessarily has signed in or is otherwise recognized), he can then browse various pages of the site, with the server 12 monitoring these actions in real-time, as described in the flow chart of FIG. 3. More specifically, each page viewed by the visitor is added to the record of the visitor. The visitor can also order goods or services on line, send e-mail to various departments associated with the website and providing support, such as sales, marketing, customer service, returns, etc. As mentioned above, some websites also give the visitor the opportunity to chat with an agent. One service providing this capability is the above-named LivePerson company.

However, some visitors feel more safe and comfortable if they can talk to a customer representative via the telephone. For this purpose, at least some of the pages provide the visitor with an opportunity to get further help through a direct, one-to-one telephone conversation with an agent. For example, some pages may contain a box with the legend “DO YOU WANT TO TALK TO A LIVE AGENT? CLICK HERE.” The server 12 checks if any visitor has requested a telephone assistance at regular intervals, as indicated at step 122. If no such request is received, in step 124 a check is performed to determine if the visitor has left. When he leaves, his record is closed and stored in memory 26 (step 126) until the next visit. Otherwise, the actions of the visitors are continued to be monitored, as shown in step 120.

Referring back to step 122, if a visitor does request telephone assistance, then in step 128 a check is performed to determine if there are any agents on duty. The live coverage provided by an e-commerce merchant may be discretionary. For example, a merchant may provide live agents a couple of hours on working days, while other merchants may provide live agents 24/7. If there is no agent on duty, then in step 130, the visitor is presented with the options to leave a text message, a voice message with his telephone number, or retry later. In yet another embodiment, if no agent is available, then step 122 could be omitted, or the box associated with telephone assistance may be modified to show that no agents are on duty, even before the visitor clicks on the box.

If in step 128 it is determined that there is an agent on duty, then in step 132 a window is opened for managing the telephone event and a check is performed to determine if a telephone number is available for the visitor. For example, if the visitor is a customer or has registered previously, his telephone number may be part of his record. If no telephone number has been previously obtained, then in step 134 the visitor is asked for the number where he wants to be reached. Additional information may also be requested from the visitor and entered into the record automatically. This information may include a description of the product, service that he is interested in, a description of any problems that he may have encountered with the product, service, the website 12 itself, or other information. All this information is processed preferably through the window opened for this purpose in step 132. Then in step 136 the visitor is placed in a queue with other visitors. As long as the window remains open, the system assumes that the visitor is still interested, even if starts performing other tasks on his device, or visits other websites.

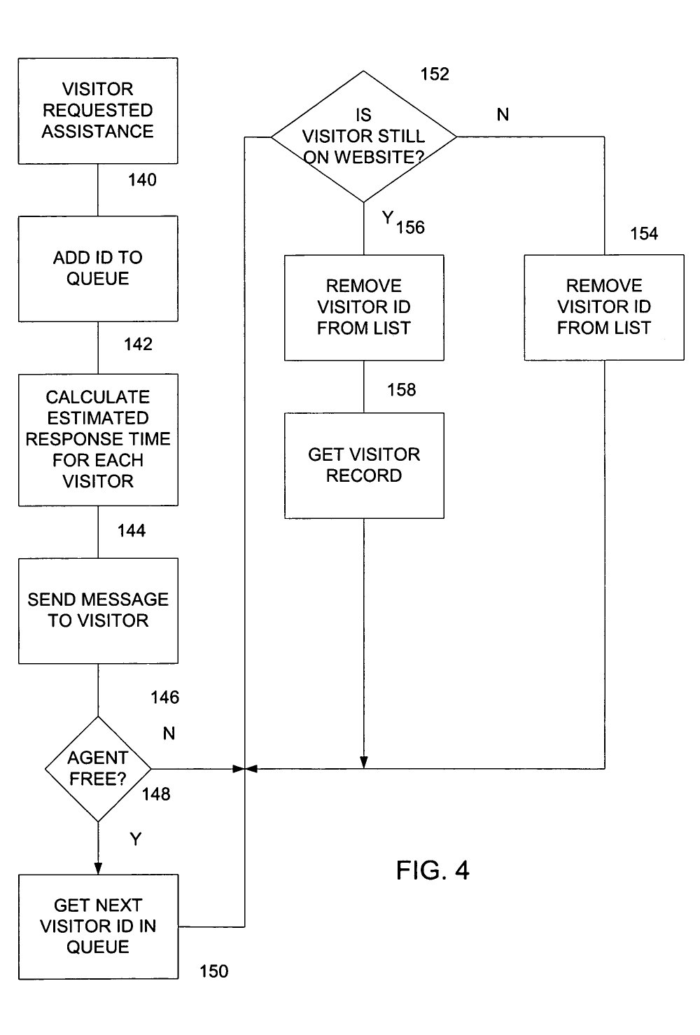

Details of the queuing process are shown in FIG. 4. In step 140 a request is received from a new visitor. In step 142 an ID associated with the visitor, including his record is added to the queue. In step 144 the server 12 determines an estimated time for responding to the requests from each visitor in the queue. This estimate may be made based on the number of visitors in the queue, the average time spent by an agent per visitor and the number of agents on duty. Of course other criteria may be used to determine an estimated response time as well. A message is then generated in step 146 indicating some information about how long is the wait for the next free agent. The information may include the position of each visitor in the queue, the expected waiting time derived in step 144, etc. For example, the message may indicate that the visitor is 6^{th} on line, 3^{rd} on line, etc. The message can appear as a pop-up message. Keeping visitors informed about the their position in the queue and how long they still have to wait is important because it gives visitors a feeling that the system/merchant cares about its customers and is trying to accommodate them.

In step 146 a determination is made as to whether an agent is free or not. If there is no free agent, the process recycles to step 144. Steps 140, 142 may be repeated on the fly for each new visitor.

While waiting for the next available agent, the visitor is free to browse through the website and hopefully is still available. However, while waiting, the visitor may have lost interest, or may have decided to go on to other tasks. In step 148 an agent becomes free and is presented with either the next visitor on the queue, or more preferably, he sees all or a substantial number of visitors requesting a live agent. In step 152 a check is performed to determine if the visitor or visitors in the queue are still interested, and that the windows opened on their PCs are still open and active. If a visitor closes the managing window opened in step 132 then the system assumes that the visitor is no longer interested in talking to the agent at this time. Therefore in step 154 his ID is removed from the queue and the system cycles to step 144. Optionally, an e-mail is automatically generated indicating that the visitor has missed his telephone call, and inviting him to visit and try the system at a future date.

As discussed above, in one embodiment, the system presents the agent with the ID and other information about the next visitor on the queue. Alternatively, the system can display information about several visitors at once, and the agent can decide which visitor he will handle next. He may make this determination based on his experience and the profile of the visitor, e.g., whether the visitor has browsed the website previously, or not, whether he is registered or not, etc. In one embodiment of the invention, visitors may register and several classes (e.g. silver, gold, platinum) of visitors may be established. The system can then generate several queues for the agents, one for gold members, one for silver, one for platinum, one for non-members, one for first time visitors, etc.

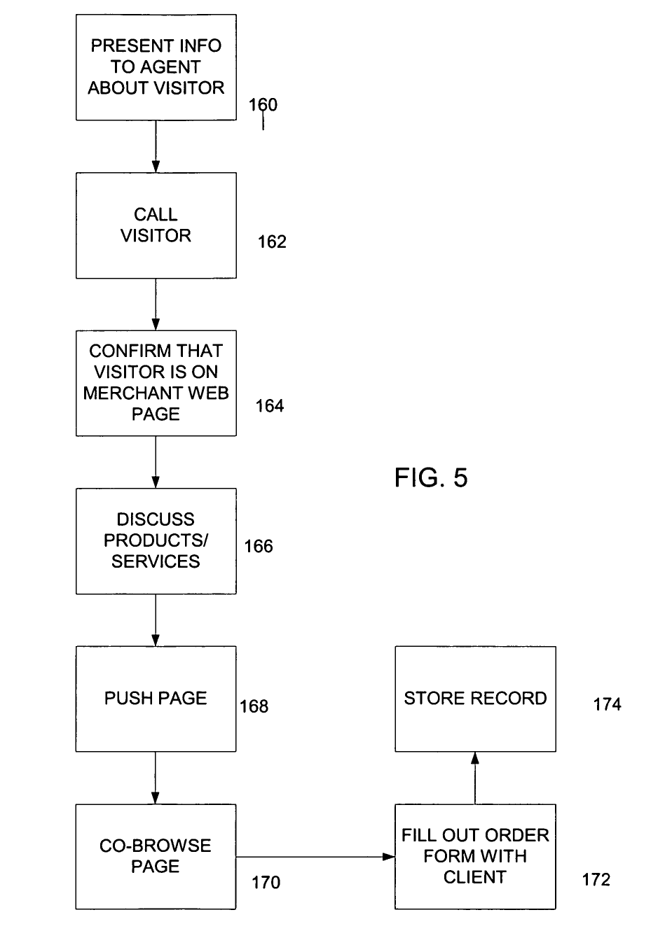

Using one or more of these criteria, the agent then selects the next visitor to be serviced. If the visitor is still available, then in step 156 his name is removed from the queue. In step 158 the agent is presented with the visitor's record (including his telephone number). The agent then contacts the visitor, preferably using his VOIP telephone 20, as discussed above. An actual conversation between an agent and a visitor is performed as shown in FIG. 5.

In step 160 the system automatically generates a call that connects the agent and the visitor. Once voice communication is established, the agent receives oral questions from the visitor, and provides oral responses directly (step 162). During this step 162, the agent's workstation and the visitor's PC are coupled so that while the agent and visitor talk to each other, the agent can see the pages that the visitor has seen, as well as the page the visitor is viewing currently. In some situations, it is more convenient to present the visitor with information from the website rather then just giving him verbal information. Therefore, the agent can push pages from the website to the visitor as well (Step 164). The agent and visitor can also co-browse other pages of the website.

Optionally, once all the visitor's questions are answered, the visitor can fill out a form on the website to complete a transaction, or the agent and visitor can cooperate to fill out the form (step 168).

Alternatively, the agent can get all the required information orally from the visitor and complete all or most of an order form himself.

Many of the functions associated with steps 162-168 are similar to the functions performed by a system when an agent chats on line with the visitor.

Once the conversation between the agent and visitor terminates (whether it results in a transaction or not), the visitor signs off (step 170). The agent then completes the visitor's record by entering any information he has received from the visitor in step 172 (unless he has already done so during the conversation with the visitor) including the call outcome such as sales amount and lead value. Next, in step 174 the record is stored until the next visit, and the agent is ready to assist the next visitor.

As mentioned above, preferably, the agent uses a VOIP-type telephone system for this exchange, while the visitor uses a separate telephone 32 connected to a standard POTS switching system 38. One of the advantages of this system is that the telephone number of the visitor appears on the record presented to the agent and the agent has only to point and select the number on his screen thereby having the system initiate the call. The call is then completed through the POTS 38 as shown.

However, the system may also be easily implemented by having the visitor use a VOIP system as well. Alternatively, the agent could call the visitor using a standard telephone or a cell phone 20A connected via standard telephone channels to the POTS 38, and ultimately to the telephone 32.

In either case, the system has several advantages over the prior art. First, in a standard sales environment, a potential customer places a call to a customer service representative. Normally, the number is busy, or he is put on hold and has to wait for long time periods (periods of up to an hour are not unheard of). During this time, he has very little that he can do besides listening to music piped on the telephone, interrupted by commercials or inaccurate representations that he has to wait x minutes more for the next operator. In the present system, the visitor can continue browsing the web or even perform other tasks, since the agent is the one who will normally call him back.

Another advantage of the system is that once a visitor is registered and provides his telephone number, he is free to request telephone assistance with a click of a button and without the need of entering his telephone number or other information entered at the time the telephone assistance request was initiated.

In another embodiment of the invention, in some instances, the visitor may prefer to call the agent rather then vice versa. For these instances, the visitor provides his telephone number and the agent uses a caller ID number to identify the visitor correctly without any positive actions by the visitor. In another embodiment, the visitor may be given a unique 800 number to call. The agent can then easily identify the visitor from the number being called. In yet another embodiment, the visitor requests on line a telephone assistance session and he is given a number to call together with a code name or code number. When the visitor calls in, he is requested to give his code number and this code number is used to identify and recall the record associated with the visitor. Once the agent has the record in front of him, he can ask the visitor to get on the website and they can co-browse its pages as described above.

The telephone assistance can be easily incorporated into existing e-commerce software. For example, if the system is providing assistance through a chat session between the visitor and the agent, the same agent can upgrade to a telephone assistance session. For this purpose, the agent can request the telephone number of the visitor and then call the visitor and continue the session where it was left off during the chat session.

As discussed above, during the telephone assistance session, the communication between the agent and visitor is very interactive, with the agent or may be the visitor pushing pages to each other, the two parties co-browsing or co-navigating the web page, joint form filling, highlighting of particular portions on a webpage, and so on.

The agent can be much more effective during the session described herein then during a standard telephone session, because at all times the agent has important information about the visitor, including the visitor's geographic location, navigation path, information about any referrer or search engine, etc.

The personal interaction between the agent and the visitor is very valuable for both parties. The visitor is dealing with a live human being instead of an automated voice messaging system. Moreover, the visitor may not want to call the agent for various reasons, including costs. By having the agent call the visitor, the visitor saves on the cost of a long distance call. This feature is especially important for international visitors. The visitor's whole experience during the session is enhanced by the seamless interface with the agent and the fact that the agent already has everything important literally at his fingertips, and thus respond to the visitor virtually instantaneously.

The agent benefits from the interaction with the visitor and gains insight on what the visitor is interested in at that particular moment, as well as generally, and use this information for co-selling other items during the same encounter or another future encounter.

Of course, the main reason for providing a system for telephone interaction between a visitor and an agent is to insure a user-friendly experience for the visitor during which any and all his questions are properly answered by a live person. This mode of operation then encourages the visitor to return to the website in the future even if he has not made a purchase during the current encounter. As mentioned above, the system captures information about each visitor, including the referrer (the webpage, email, or other document that sent the visitor to the present merchant's website). This information is incorporated into the record of the visitor and is also made available to the agent. The referrer information can be parsed to determine details on how the visitor arrived to the web site such as domain, page and, for a search engine, the relevant keywords, a relevant online campaign (banner, email) and so on. During or after an encounter with the visitor, the agent then uses at least some of this information and information obtained from the visitor to generate a report on the encounter. Information from the report is stored in the visitor's file and may be used for other purposes as well. For example this information (referrer information) combined with the call outcome information completed by the agent may be used to generate reports on the effectiveness of campaigns (banner, email and so on), effectiveness of search engines and keywords, and to calculate revenues payable to referrers, and so on. Any information about purchases, including items or services by the visitor, the values of these purchases, etc., are also recorded and compiled.

Numerous modifications may be made to the invention without departing from its scope as defined in the appended claims

We claim:

1. A system for providing information to a visitor of a website comprising:
generating a record including information about the visitor;
providing a selector on said website that when selected indicates that the visitor wants to establish telephone communication with a live agent;
determining if a live agent is currently available;
establishing communication between said live agent and the visitor; and
performing a telephone conversation with the visitor.

2. The method of claim 1 wherein said telephone communication is established by placing a call by said agent.

3. The method of claim 2 further comprising retrieving said record, including retrieving the telephone number of said visitor and enabling said agent to automatically select said telephone number for dialing.

4. The method of claim 1 further comprising performing co-browsing by said visitor and said agent.

5. The method of claim 1 further comprising filling a form jointly by said agent and said visitor, said form residing on said website.

6. The method of claim 1 further comprising assigning a code to said visitor, wherein said telephone communication is established by said visitor calling said agent and using said code.

7. The method of claim 6 further comprising retrieving said record by said agent using said code.

8. The method of claim 1 wherein at least one of said agent and said client use a VOIP telephone for establishing said telephone communication channel.

9. The method of claim 1 further comprising generating a queue for a plurality of visitors requesting telephone communications, said queue determining the order in which said visitors are connected to said live agent.

10. The method of claim 9 further comprising generating an expected response time for each visitor on the queue and presenting said times to said visitors.

11. The method of claim 10 wherein said expected to response time is provided to all visitors, independently of whether they have requested said telephone communication.

12. The method of claim 1 further comprising generating a record for each conversation.

13. The method of claim 12 wherein said record includes information identifying the referrer of the visitor.

14. The method of claim 13 wherein said information includes at least one of the referrer's site, the referrer's page, keywords used at the referrer's site to get to the present page, or the referrer's domain.

15. The method of claim 1 wherein a plurality of visitors are placed in a queue and wherein said agent selects the next visitor from said queue based on a predetermined criteria.

16. A system for providing information to a website visitor comprising:
a server connected to the Internet and providing a website accessible from the Internet; and
a workstation accessing said server and being operated by a live agent;
said server providing access to said website to a visitor, generating a record for the visitor including visitor specific information of one of the visitor's current and past activities on the website;
said server presenting to said visitor a selector which when selected indicates to the system that the visitor desires a telephone communication channel to said live agent and that a live agent is presently available.

17. The system of claim 16 wherein the website is visited by a plurality of visitors requesting telephone communications and wherein said server establishes a queue for said requests.

18. The system of claim 16 wherein said workstation includes a telephone.

19. The system of claim 18 wherein said telephone uses a VOIP protocol.

20. The system of claim 16 wherein said workstation establishes voice communication between said live agent and said visitor in response to the activation of said selector.
